(19) United States
(12) Patent Application Publication
(10) Pub. No.: US 2020/0112767 A1
(43) Pub. Date: Apr. 9, 2020

(54) ARTIFICIAL INTELLIGENCE OPTIMIZED PLAYBACK EXPERIENCE

(71) Applicant: Marvin DeMerchant, San Diego, CA (US)

(72) Inventor: Marvin DeMerchant, San Diego, CA (US)

(73) Assignee: Sony Corporation, Tokyo (JP)

(21) Appl. No.: 16/152,275

(22) Filed: Oct. 4, 2018

(51) Int. Cl. H04N 21/45; H04N 21/41; H04N 21/442

(52) U.S. Cl. CPC H04N 21/4516; H04N 21/4532; H04N 21/44231; H04N 21/4104

(57) ABSTRACT

Implementations generally relate to an artificial intelligence agent that provides optimized playback experience. In some implementations, a method includes receiving, at an agent device, a media content request from a user. The method further includes determining a plurality of devices that are connected to the agent device. The method further includes determining device capabilities of each device of the plurality of devices, wherein the device capabilities are associated with media content. The method further includes selecting a target device from the plurality of devices based on one or more predetermined selection criteria.

### BACKGROUND

People typically have many sources of media content to play and enjoy. However, users typically struggle to find the content that they would like to watch and then decide the best device for playback. Users may also be limited by particular applications for viewing media content available on particular devices. Conventional solutions do not provide adequate means for achieving the best experience with the devices and services.

### SUMMARY

Implementations generally relate to an artificial intelligence optimized playback experience. In some implementations, a system includes one or more processors, and includes logic encoded in one or more non-transitory computer-readable storage media for execution by the one or more processors. When executed, the logic is operable to perform operations including receiving, at an agent device, a media content request from a user; determining a plurality of devices that are connected to the agent device; determining device capabilities of each device of the plurality of devices, wherein the device capabilities are associated with media content; and selecting a target device from the plurality of devices based on one or more predetermined selection criteria.

With further regard to the system, in some implementations, the agent device is integrated with a soundbar. In some implementations, the agent device is integrated with a television. In some implementations, the device capabilities comprise an ability to access subscription media content. In some implementations, the device capabilities comprise an ability to store media content. In some implementations, the predetermined selection criteria comprise selecting the target device based on speed of delivering media content. In some implementations, the predetermined selection criteria comprise selecting the target device based on one or more user preferences.

In some embodiments, a non-transitory computer-readable storage medium with program instructions thereon is provided. When executed by one or more processors, the instructions are operable to perform operations including receiving, at an agent device, a media content request from a user; determining a plurality of devices that are connected to the agent device; determining device capabilities of each device of the plurality of devices, wherein the device capabilities are associated with media content; and selecting a target device from the plurality of devices based on one or more predetermined selection criteria.

With further regard to the computer-readable storage medium, in some implementations, the agent device is integrated with a soundbar. In some implementations, the agent device is integrated with a television. In some implementations, the device capabilities comprise an ability to access subscription media content. In some implementations, the device capabilities comprise an ability to store media content. In some implementations, the predetermined selection criteria comprise selecting the target device based on speed of delivering media content. In some implementations, the predetermined selection criteria comprise selecting the target device based on one or more user preferences.

In some implementations, a method includes receiving, at an agent device, a media content request from a user. The method further includes determining a plurality of devices that are connected to the agent device. The method further includes determining device capabilities of each device of the plurality of devices, wherein the device capabilities are associated with media content. The method further includes selecting a target device from the plurality of devices based on one or more predetermined selection criteria.

With further regard to the method, in some implementations, the agent device is integrated with a soundbar. In some implementations, the agent device is integrated with a television. In some implementations, the device capabilities comprise an ability to access subscription media content. In some implementations, the device capabilities comprise an ability to store media content. In some implementations, the predetermined selection criteria comprise selecting the target device based on speed of delivering media content.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example media environment, which may be used for implementations described herein.

FIG. 2 illustrates an example flow diagram for optimizing media playback experience, according to some implementations.

FIG. 3 illustrates a block diagram of an example network environment, which may be used for some implementations described herein.

FIG. 4 illustrates a block diagram of an example computing system, which may be used for some implementations described herein.

### DETAILED DESCRIPTION

Implementations described herein provide an artificial intelligence (AI) optimized playback experience. As described in more detail herein, implementations provide an AI agent that controls multiple devices directly and/or indirectly, and controls apps. As such, the AI agent controls devices and apps in order to provide media content, games, and settings and preferences for an optimized playback experience. The AI agent locates and selects preferred media content from multiple sources and starts playback with the best audio and visual experience for the current user or group of users.

As described in more detail herein, in various implementations, a system receives, at an agent device, a media content request from a user. The system further determines devices that are connected to the agent device. The system further determines device capabilities of each device of the devices, where the device capabilities are associated with media content. The system further selects a target device from the plurality of devices based on one or more predetermined selection criteria.

Although implementations disclosed herein are described in the context of an AI agent residing in a soundbar, these implementations and others may also apply to an AI agent residing in a television.

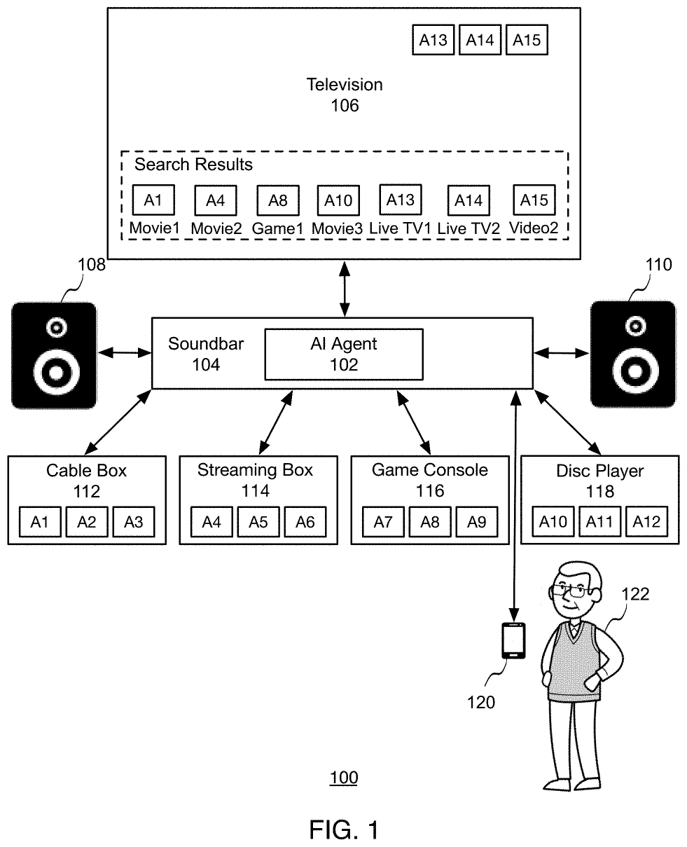

FIG. 1 illustrates a block diagram of an example media environment 100, which may be used for some implementations described herein. In some implementations, media environment 100 includes an AI agent 102 in a soundbar 104, a television 106, speakers 108 and 110, a cable box 112, a streaming box 114, a game console 116, a disc player 118, a mobile device 120, and a user 122.

In various implementations, AI agent 102 is a device that has AI capabilities. AI agent 102 controls multiple devices and apps in order to provide media content such as movies and television shows. AI agent 102 may also provide games for an optimized playback experience.

In various embodiments, AI agent 102 receives commands (e.g., voice commands, etc.) from a user such as user 122. AI agent 102 may access voice commands from the user via an open microphone (not shown) that is integrated with soundbar 104. As described in more detail herein, AI agent 102 determines possible sources for accessing media content based on the user's request. AI agent 102 checks media content subscriptions and apps that are installed on the various devices connected with AI agent 102. AI agent 102 also checks for media content stored on the various devices. AI agent 102 also checks for user preferences. AI agent 102 then selects an optimal source of the media content and causes the media to be presented to the user. In various implementations, soundbar 104 may include an audio receiver to enable soundbar 104 to play audio for music and/or other media content such as movies, television shows, etc.

In some implementations, AI agent 102 is integrated with a soundbar such as soundbar 104. While some implementations are described herein in the context of an AI agent residing in a soundbar, these implementations also apply to an AI agent that is integrated with other devices or located in other locations. For example, in some implementations, the AI agent may be a television such as television 106. In some implementations, the AI agent may be located in the cloud. Implementations described herein may be implemented by AI agent 102 and/or in combination with any device communicating with and/or controlled by AI agent 102.

In various implementations, various devices have the capability of downloading software applications (apps), which may be used for various purposes such as accessing and viewing media content. As shown, for example, cable box 112 has apps A1, A2, and A3. Streaming box 114 has apps A4, A5, and A6. Game console 116 has apps A7, A8, and A9. Disc player 118 has apps A10, A11, and A12. Television 106 has apps A13, A14, and A15. The search results shown on television 106 are described in more detail herein.

For ease of illustration, FIG. 1 shows one block for each of AI agent 102, soundbar 104, television 106, speakers 108 and 110, cable box 112, streaming box 114, game console 116, disc player 118, and mobile device 120. Each of these blocks may represent multiple media devices. In other implementations, media environment 100 may not have all of the components shown and/or may have other elements including other types of elements instead of, or in addition to, those shown herein. In various implementations, user 122 interacts with AI agent 102 and/or with the other media devices directly via a control device or by voice. In the various implementations described herein, a processor of AI agent 102 may cause the elements described herein (e.g., settings, commands, messages, user preferences, etc.) to be displayed in a user interface on one or more display screens.

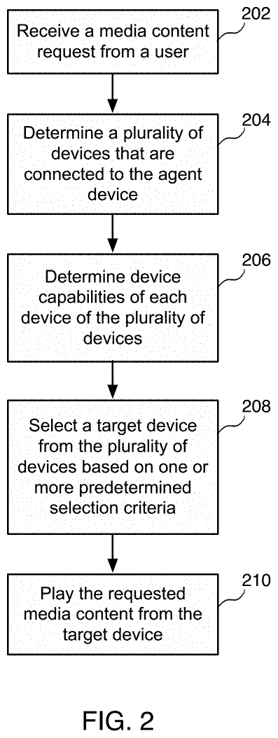

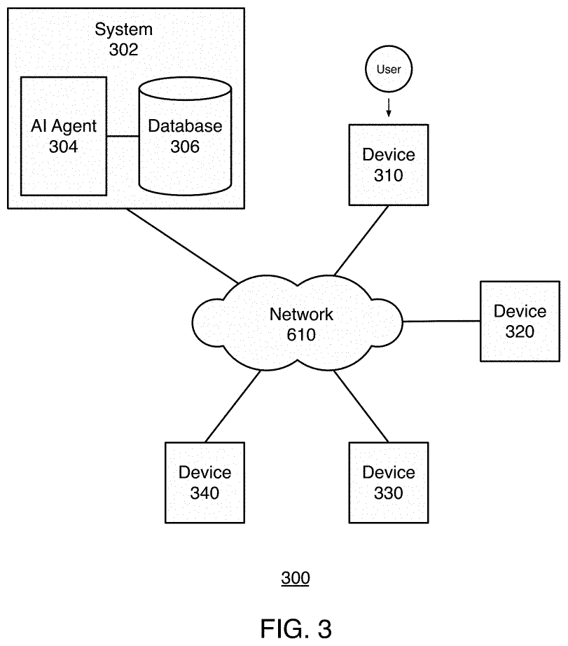

FIG. 2 illustrates an example flow diagram for optimizing media playback experience, according to some implementations. Referring to both FIGS. 2 and 3, a method is initiated at block 202, where the system such as AI agent 102 receives a media content request from a user. In some implementations, AI agent 102 determines the type of media content (e.g., movie, television show, game, etc.). In some implementations, the request may be for a specific media content item (e.g., a particular movie title). In some implementations, the request may be for a general media content category (e.g., a movie genre).

While example implementations are described herein in the context of an individual user such as user 122, these implementations and others may also apply in the context of multiple users (e.g., a family of users, etc.). AI agent 102 may maintain and/or access profiles associated with individual users and/or groupings of users.

At block 204, the system/AI agent 102 determines the devices that are connected to the agent device. In various scenarios, a user may have multiple sources of media content such as those shown in FIG. 1.

At block 206, the system/AI agent 102 determines device capabilities of each device of those connected to the system/AI agent 102. As described in more detail herein, the device capabilities are associated with media content. For example, in various implementations, the device capabilities comprise an ability to access subscription media content. In various implementations, the device capabilities comprise an ability to store media content. In various implementations, the device capabilities include apps stored on each device and media content accessible by the apps. The media content may be stored locally or accessed remotely via one or more subscriptions.

In various implementations, AI agent 102 may cause a control overly to be displayed (e.g., displayed on television 106) to provide search results. The search results include one or more suggested media content items and one or more associated apps from the respective connected devices.

Referring again to FIG. 1, an app on television 106 overlays search results from AI agent 102, in response to the media content request from a user. As shown, the search results include apps and associated media content. In other words, the media content request may result in multiple apps and multiple corresponding sources (e.g., multiple devices) that are available to provide the media content of interest. For example, app A1 from cable box 112 has a movie Movie1 resulting from the media content request. App A4 from streaming box 114 has a movie Movie2 resulting from the media content request. App A8 from game console 116 has a game Game1 resulting from the media content request. Apps A13, A14, and A15 from television 106 have television shows Live TV1 and Live TV2 and video Video2 resulting from the media content request.

In some implementations, the capabilities of the individual devices may be stored on the devices and accessed by AI agent 102. In some implementations, the capabilities of the individual devices may be stored on a particular device such as AI agent 102 or a device with which AI agent 102 is integrated such as soundbar 104.

In some implementations, AI agent 102 may determine different costs for the requested media content based on the sources of media content. For example, a particular movie may be locally stored or included in one or more subscriptions. The same movie may be available for an on-demand fee.

At block 208, the system/AI agent 102 selects a target device from the devices based on one or more predetermined selection criteria. In some implementations, the system may select more than one target device, in which case system may enable the user to select a target device to source the media content.

In various implementations, the predetermined selection criteria comprise selecting the target device based on speed of delivering media content. For example, locally stored media content may be delivered faster that streaming media content.

In various implementations, the predetermined selection criteria comprise selecting the target device based on quality of delivering media content. For example, AI agent 102 may identify the device that supports the best video and audio format (e.g., HDR, Dolby Atmos, etc.).

In various implementations, the predetermined selection criteria comprise selecting the target device based on one or more user preferences. In some implementations, AI agent 102 may enable the user to select preferred devices or preferred settings for the delivery of media content. AI agent 102 may enable the user to select preferred content subscriptions. AI agent 102 may enable the user to select preferred device settings. AI agent 102 may select the target device based at least in part on such user preferences. In some implementations, AI agent 102 may consult the behaviors of other users in order to determine the best results for this user. AI agent 102 may select the target device based at least in part on such behaviors, or in combination with other factors.

In some implementations, AI agent 102 may determine the particular user based on the detected voice. AI agent 102 may determine the user's past behavior, and select the target device accordingly, based on the user's past behavior.

Implementations facilitate a search for media content when the media content is available from different sources. Implementations make suggestions to a user in order to provide the optimal source of media content, based on speed, quality, cost, and/or user preferences.

At block 210, the system/AI agent 102 plays the requested media content from the target device. In various embodiments, AI agent 102 starts playback and presents alternative search results and playback options like configuring theatre mode by dimming lights, changing to Dolby or Atmos with HDR playback, etc. If any of the alternative options are selected the agent will learn those options for future use. In some implementations, if a given target device is not logged into a particular remote source of media content, AI agent 102 may log into the source of media content in order to access the media content.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

Implementations described herein provide various benefits. For example, implementations facilitate a search for media content when the media content is available from different sources. Implementations make suggestions to a user in order to provide the optimal source of media content, based on speed, quality, and/or cost.

FIG. 3 illustrates a block diagram of an example network environment 300, which may be used for some implementations described herein. In some implementations, network environment 300 includes a system 302, which includes an AI agent 304 and a database 306. Network environment 300 also includes client devices 310, 320, 330, and 340, which may communicate with each other directly or via system 302. Network environment 300 also includes a network 350.

For ease of illustration, FIG. 3 shows one block for each of system 302, server device 304, and network database 306, and shows four blocks for client devices 310, 320, 330, and 340. Blocks 302, 304, and 306 may represent multiple systems, AI agents, and databases. Also, there may be any number of client devices. In other implementations, network environment 300 may not have all of the components shown and/or may have other elements including other types of elements instead of, or in addition to, those shown herein.

In the various implementations described herein, a processor of system 302 and/or a processor of any client device 310, 320, 330, and 340 causes the elements described herein (e.g., information, etc.) to be displayed in a user interface on one or more display screens.

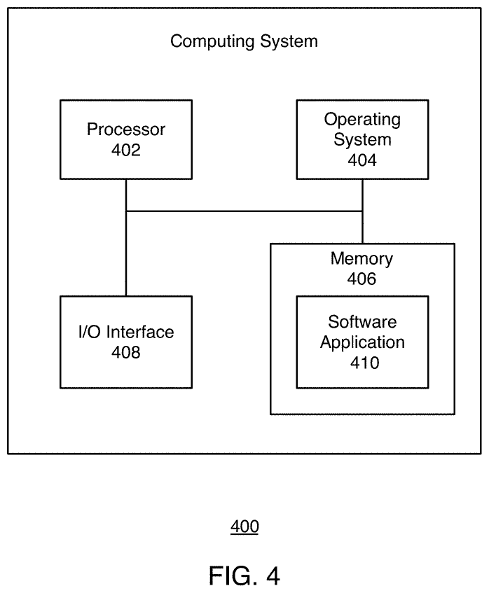

FIG. 4 illustrates a block diagram of an example computing system 400, which may be used for some implementations described herein. In some implementations, computing system 400 may include a processor 402, an operating system 404, a memory 406, and an input/output (I/O) interface 408. In various implementations, processor 402 may be used to implement various functions and features described herein, as well as to perform the method implementations described herein. While processor 402 is described as performing implementations described herein, any suitable component or combination of components of computing system 400 or any suitable processor or processors associated with computing system 400 or any suitable system may perform the steps described. Implementations described herein may be carried out on a user device, on a server, or a combination of both.

Computing system 400 also includes a software application 410, which may be stored on memory 406 or on any other suitable storage location or computer-readable medium. Software application 410 provides instructions that enable processor 402 to perform the implementations described herein and other functions. Software application may also include an engine such as a network engine for performing various functions associated with one or more networks and network communications. The components of computing system 400 may be implemented by one or more processors or any combination of hardware devices, as well as any combination of hardware, software, firmware, etc.

For ease of illustration, FIG. 4 shows one block for each of processor 402, operating system 404, memory 406, I/O interface 408, and software application 410. These blocks 402, 404, 406, 408, and 410 may represent multiple processors, operating systems, memories, I/O interfaces, and software applications. In various implementations, computing system 400 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to perform operations comprising:
receiving, at an agent device, a media content request from a user;
determining a plurality of devices that are connected to the agent device;
determining device capabilities of each device of the plurality of devices, wherein the device capabilities are associated with media content; and
selecting a target device from the plurality of devices based on one or more predetermined selection criteria.

2. The system of claim 1, wherein the agent device is integrated with a soundbar.

3. The system of claim 1, wherein the agent device is integrated with a television.

4. The system of claim 1, wherein the device capabilities comprise an ability to access subscription media content.

5. The system of claim 1, wherein the device capabilities comprise an ability to store media content.

6. The system of claim 1, wherein the predetermined selection criteria comprise selecting the target device based on speed of delivering media content.

7. The system of claim 1, wherein the predetermined selection criteria comprise selecting the target device based on one or more user preferences.

8. A non-transitory computer-readable storage medium with program instructions stored thereon, the program instructions when executed by one or more processors are operable to perform operations comprising:
receiving, at an agent device, a media content request from a user;
determining a plurality of devices that are connected to the agent device;
determining device capabilities of each device of the plurality of devices, wherein the device capabilities are associated with media content; and
selecting a target device from the plurality of devices based on one or more predetermined selection criteria.

9. The computer-readable storage medium of claim 8, wherein the agent device is integrated with a soundbar.

10. The computer-readable storage medium of claim 8, wherein the agent device is integrated with a television.

11. The computer-readable storage medium of claim 8, wherein the device capabilities comprise an ability to access subscription media content.

12. The computer-readable storage medium of claim 8, wherein the device capabilities comprise an ability to store media content.

13. The computer-readable storage medium of claim 8, wherein the predetermined selection criteria comprise selecting the target device based on speed of delivering media content.

14. The computer-readable storage medium of claim 8, wherein the predetermined selection criteria comprise selecting the target device based on one or more user preferences.

15. A computer-implemented method comprising:
receiving, at an agent device, a media content request from a user;
determining a plurality of devices that are connected to the agent device;
determining device capabilities of each device of the plurality of devices, wherein the device capabilities are associated with media content; and
selecting a target device from the plurality of devices based on one or more predetermined selection criteria.

16. The method of claim 15, wherein the agent device is integrated with a soundbar.

17. The method of claim 15, wherein the agent device is integrated with a television.

18. The method of claim 15, wherein the device capabilities comprise an ability to access subscription media content.

19. The method of claim 15, wherein the device capabilities comprise an ability to store media content.

20. The method of claim 15, wherein the predetermined selection criteria comprise selecting the target device based on speed of delivering media content.
